(19) United States
(12) Patent Application Publication
(10) Pub. No.: US 2023/0134745 A1
(43) Pub. Date: May 4, 2023

(54) COMPUTING DEVICES WITH HINGE BARS

(71) Applicant: HEWLETT-PACKARD DEVELOPMENT COMPANY, L.P., SPRING, TX (US)

(72) Inventors: HYUNMIN MOON, SPRING, TX (US); ILCHANG LEE, SPRING, TX (US)

(21) Appl. No.: 17/996,139

(22) PCT Filed: Apr. 22, 2020
(86) PCT No.: PCT/US2020/029244

§ 371 Date: Oct. 13, 2022

(51) Int. Cl. G06F 1/16

(52) U.S. Cl. CPC G06F 1/1681; G06F 1/1616; G06F 1/1669

(57) ABSTRACT

Example implementations relate to computing devices with hinge bars, in some examples, a computing device may include a cover with a flexible hinge, a first housing, a first display device included in the first housing, a second housing, a second display device included in the second housing, and a hinge bar located between the first housing and the second housing, where the hinge bar includes an input/output port at an end of the hinge bar, and the hinge bar is electrically connected to the first display device via a first electrical pathway located in the cover and to the second display device via a second electrical pathway located between the second display device and the hinge bar.

### BACKGROUND

A computing device can allow a user to utilize computing device operations for work, education, gaming, multimedia, and/or other uses. Computing devices can be utilized in a non-mobile setting, such as at a desktop, and/or be portable to allow a user to carry of otherwise bring with the computing device with while in a mobile setting.

### BRIEF DESCRIPTION OF THE DRAWINGS

FIG. 1 illustrates a perspective view of an example of a computing device with hinge bars in a first open orientation consistent with the disclosure.

FIG. 2 illustrates a partial perspective view of an example of a computing device with hinge bars having an I/O port consistent with the disclosure.

FIG. 3 illustrates a partial side view of an example of a computing device with hinge bars in a closed orientation consistent with the disclosure.

FIG. 4A a perspective view of an example of a computing device with hinge bars in a first open orientation having a keyboard housing including a keyboard consistent with the disclosure.

FIG. 4B a top view of an example of a computing device with hinge bars in a first open orientation having a keyboard housing including a keyboard consistent with the disclosure.

FIG. 5 a perspective view of an example of a computing device with hinge bars in a first open orientation having a keyboard housing including a keyboard and a palm rest consistent with the disclosure.

FIG. 6 a side view of an example of a computing device with hinge bars in a first open orientation having a keyboard housing including a keyboard and a palm rest consistent with the disclosure.

FIG. 7 illustrates a perspective view of an example of a computing device with hinge bars in a second open orientation consistent with the disclosure.

FIG. 8 illustrates a perspective view of an example of a computing device with hinge bars in a second open orientation consistent with the disclosure.

FIG. 9 illustrates a perspective view of an example of a computing device in a plurality of orientations and form factors consistent with the disclosure.

FIG. 10 illustrates a perspective view of an example of a computing device in a plurality of orientations and form factors with a keyboard housing consistent with the disclosure.

FIG. 11 is a diagram of an example computing device with hinge bars consistent with the disclosure.

### DETAILED DESCRIPTION

A user may utilize a computing device for various purposes, such as for business and/or recreational use. As used herein, the term “computing device” refers to an electronic system having a processing resource, memory resource, and/or an application-specific integrated circuit (ASIC) that can process information. A computing device can be, for example, a laptop computer, a notebook, and/or a tablet, among other types of computing devices.

A computing device can include a display device. As used herein, the term “display device” refers to an output device that includes a display area that displays information provided by an electrical signal in a visual and/or tactile form. As used herein, the term “display area” refers to an area of a display device that displays information. For example, a computing device can include a display device having a display area that can display information such as text, videos, and/or images, as a result of an electrical signal provided to the display from the computing device.

Some computing devices may include multiple display devices in order to present more information to a user. Computing devices utilizing multiple display devices can be oriented in various form-factor orientations. For example, a computing device can include a first display device included in a first housing that is connected to a second display device included in a second housing by a hinge, where the first housing and the second housing can fold relative to each other to different orientations about the hinge.

Computing devices with hinge bars, according to the disclosure can allow for a hinge bar to be located between a first display device and a second display device. The hinge bar can electrically connect a first display device and a second display device while allowing the first and second display devices to be oriented in various form-factor orientations. Further, the hinge bar can include an input/output (I/O) port, allowing the hinge bar to provide connectivity, information transfer, and/or charging to the computing device, among other capabilities.

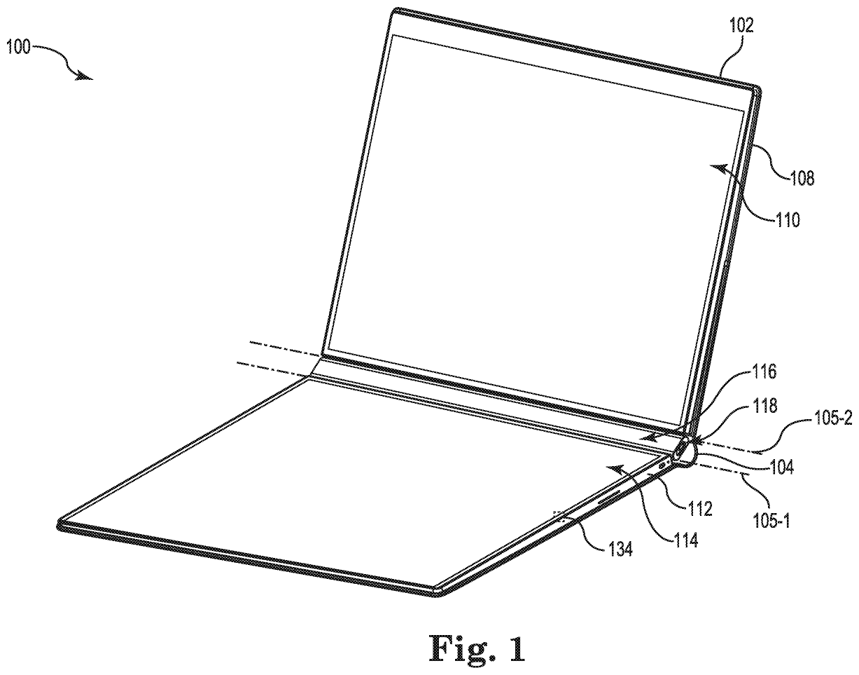

FIG. 1 illustrates a perspective view of an example of a computing device 100 with hinge bars in a first open orientation consistent with the disclosure. As illustrated in FIG. 1, the computing device 100 can include a cover 102, a first housing 108, a second housing 112, and a hinge bar 116.

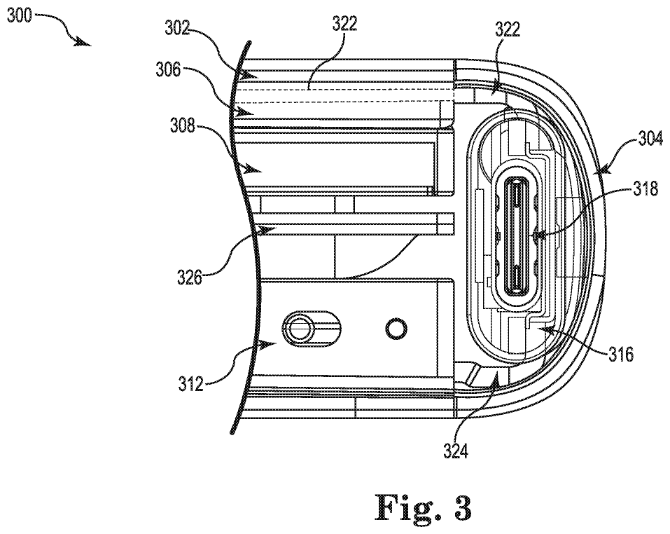

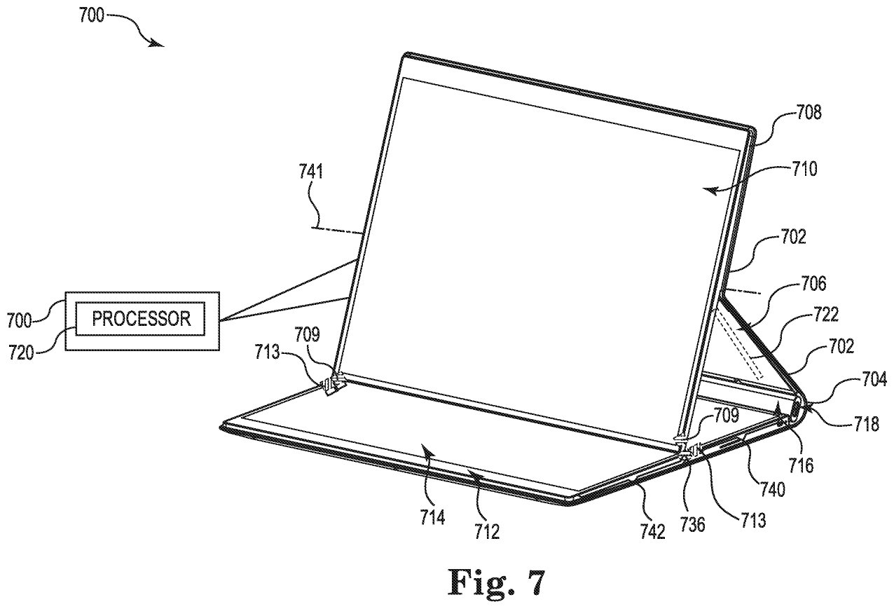

The computing device 100 can include a cover 102. As used herein, the term “cover” refers to an outer envelope of a device. For example, the cover 102 can be a material on an outer surface of the computing device 100. The cover 102 can be of a material to protect the computing device 100 from foreign objects, provide a comfortable outer surface for a user to touch (e.g., during use of the computing device 100, transit of the computing device 100 in a mobile setting, etc.), provide a pleasing aesthetic for the computing device 100, etc. The cover 102 can be a plastic material, rubber material, metallic material, leather material, and/or combinations thereof, among other types of materials. Additionally, the cover 102 can provide for the routing of electrical pathways, as is further described in connection with FIGS. 3 and 7.

The cover 102 can include a flexible hinge 104. As used herein, the term “flexible hinge” refers to a piece of material, capable of being bent and/or twisted, on which two attached portions are able to move. The flexible hinge 104 can be a rubber material, a leather material, and/or any other flexible material about which the first housing 108 and the second housing 112 can move, as is further described herein.

The flexible hinge 104 can be shaped to allow for the first housing 108 and the second housing 112 to rotate about the flexible hinge 104. As illustrated in FIG. 1, the flexible hinge 104 can be semi-circularly shaped. However, examples of the disclosure are not so limited. For example, the flexible hinge 104 can be any other shape to allow for rotation about the flexible hinge 104 by the first housing 108 and the second housing 112.

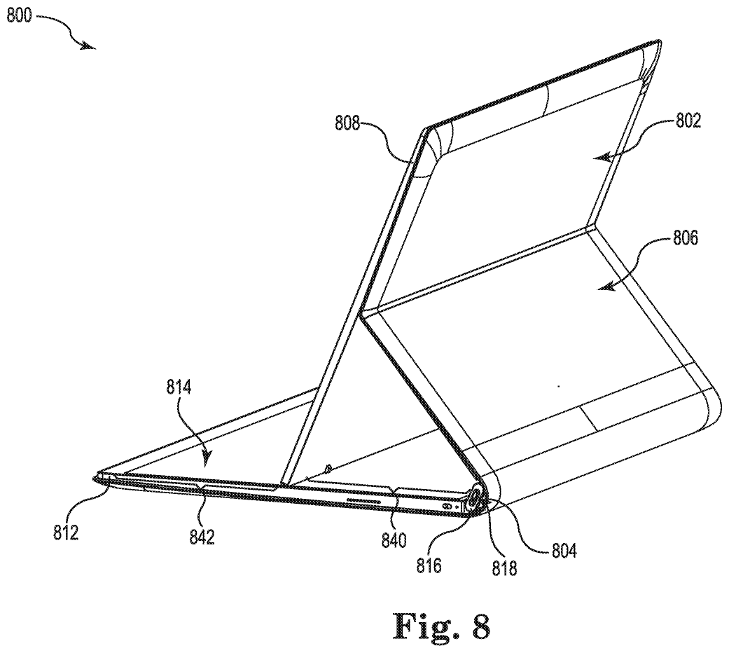

Although not illustrated in FIG. 1, the cover 102 can include a hinge arm. As used herein, the term “hinge arm” refers to a component on which an attached part rotates and is supported. For example, the first housing 108 can be attached to the hinge arm and can rotate away from the hinge arm such that the computing device 100 can be oriented in a second open orientation where the hinge arm supports the first housing 108, as is further described in connection with FIGS. 7 and 8.

The computing device 100 can include a first housing 108. As used herein, the term “housing” refers to an outer shell of a device. For example, the first housing 108 can be an outer shell making up a portion of the computing device 100. The first housing 108 can include other components of the computing device 100, such as a display device, as is further described herein.

The first housing 108 can include a first display device 110. As described above, the first display device 110 can present information to a user, such as text, videos, and/or images, as a result of an electrical signal provided to the first display device 110 from the computing device 100. For example, a user may utilize the computing device 100 to display a video via a display area of the first display device 110.

The computing device 100 can include a second housing 112. The second housing 112 can be an outer shell making up a different portion of the computing device 100 than the first housing 108. The second housing 112 can include other components of the computing device 100, such as a display device, as is further described herein.

The second housing 112 can include a second display device 114. As illustrated in FIG. 1, the display area of the second display device 114 can be exposed in a first open orientation of the computing device 100 such that the second display device 114 can present information to a user, such as text, videos, and/or images, as a result of an electrical signal provided to the second display device 114 from the computing device 100. For example, a user may utilize the computing device 100 to display text via a display area of the second display device 114.

A hinge bar 116 can be located between the first housing 108 and the second housing 112. As used herein, the term “hinge bar” refers to a component to connect a first display device to a second display device. For example, the hinge bar 116 can allow for the first display device 110 to be electrically connected to the second display device 114. The hinge bar 116 can be electrically connected to the first display device 110 via a first electrical pathway located in the cover 102 and to the second display device 114 via a second electrical pathway located between the second display device 114 and the hinge bar 116, as is further described in connection with FIG. 3.

As illustrated in FIG. 1, the hinge bar 116 can span from a first end of the computing device 100 to a second end of the computing device 100. However, examples of the disclosure are not so limited. For example, the hinge bar 116 can span a distance that is less than the distance between the first end of the computing device 100 to the second end of the computing device 100.

As illustrated in FIG. 1, the computing device 100 is in a first open orientation. As used herein, the term “first open orientation” refers to an orientation in which the first housing 108 and the second housing 112 are oriented in an open clamshell form factor. For example, the first housing 108 and the second housing 112 can be foldable relative to each other via the rotation axes 105-1 and/or 105-2. When the computing device 100 is in the first open orientation, the first housing 108 can be oriented at an angle relative to the second housing 112. As illustrated in FIG. 1, the angle between the first housing 108 and the second housing 112 can be an angle greater than 0°. For example, the angle between the first housing 108 and the second housing 112 can be an acute angle (e.g., an angle greater than 0° but less than 90°), a right angle (e.g., 90°), or an obtuse angle (e.g., an angle greater than 90° but less than 180°), and can be rotated to such angles via rotation axis 105-1. Additionally, the angle between the first housing 108 and the second housing 112 can be an angle greater than 180°, and can be rotated to such angles via rotation axis 105-2.

In some examples, the first open orientation can allow the computing device 100 to be in a laptop form factor. As used herein, the term “laptop form factor” refers to an orientation of a computing device in which a first portion of the computing device is oriented in a clamshell form-factor relative to a second portion of the computing device. For example, as illustrated in FIG. 1 the first housing 108 and the second housing 112 are oriented in the laptop form factor.

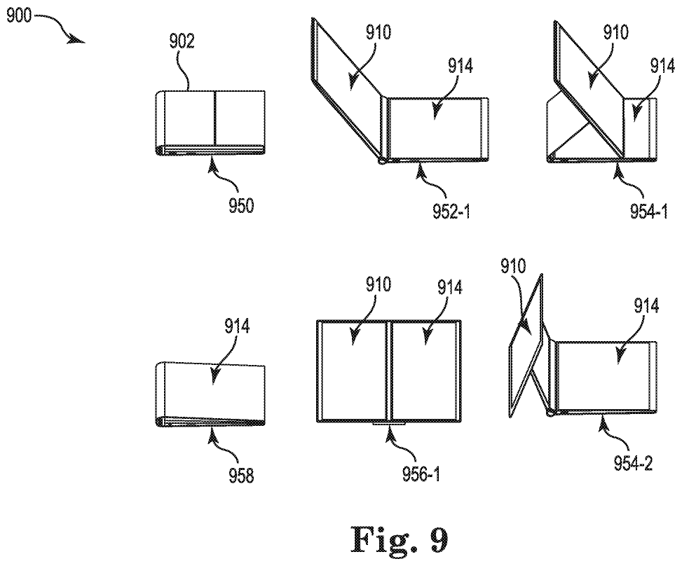

In some examples, the first open orientation can allow the computing device 100 to be in a dual-screen form factor. As used herein, the term “dual-screen form factor” refers to an orientation of a computing device in which information can be presented on multiple display devices. In some examples, the computing device 100 may be rotated 90° from the orientation illustrated in FIG. 1 in order to be oriented like an open book and be utilized to display information on both the first display device 110 and the second display device 114, as is further described in connection with FIG. 9. Although not illustrated in FIG. 1, the computing device 100 may include a sensor, such as a gyroscopic sensor, to detect the computing device 100 being rotated to the dual-screen form factor. For example, the first display device 110 and the second display device 114 can both display information such as text, videos, and/or images. The information may span both the first display device 110 and the second display device 114, may be dragged from the first display device 110 and the second display device 114 and/or vice versa, may have different information presented on the first display device 110 and the second display device 114, among other display functions.

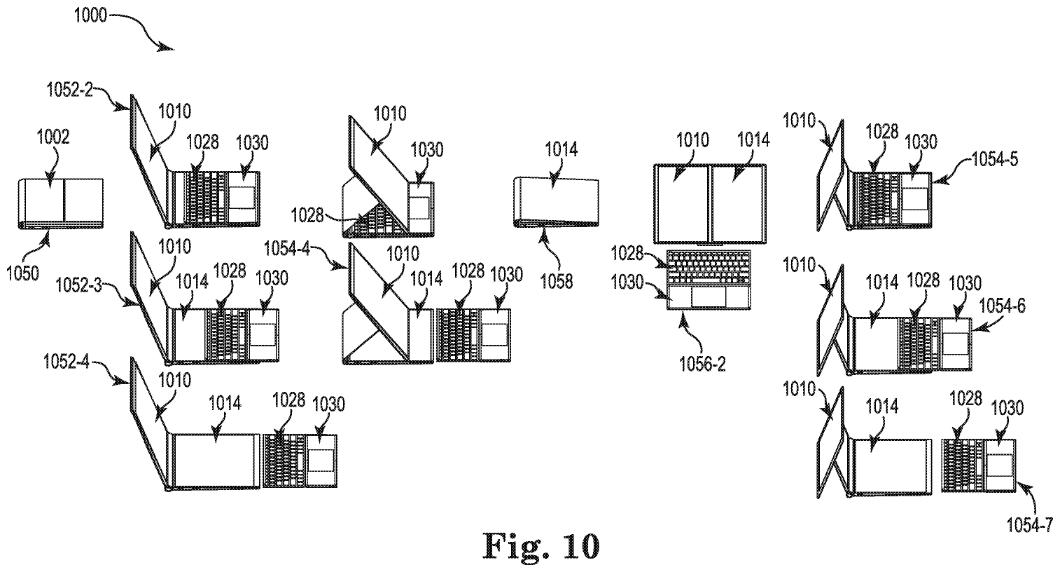

The first housing 108 and the second housing 112 can be oriented in any orientation. For example, the first housing 108 and the second housing 112 can be oriented at an angle (e.g., as illustrated in FIG. 1). The angle between the first housing 108 and the second housing 112 may be modified by rotating the first housing 108 relative to the second housing 112 and/or vice versa about the rotation axes 105-1 and/or 105-2. This can allow the user of the computing device 100 to orient the first display device 110 and/or the second display device 114 to an orientation they are comfortable with for use in a laptop form factor or a dual-screen form factor, allowing the user to view additional information while using the computing device 100. Further, additional orientations are further described in connection with FIGS. 9 and 10.

As illustrated in FIG. 1, the second housing 112 can include a sensor 134. As used herein, the term “sensor” refers to a device to detect events and/or changes in its environment and transmit the detected events and/or changes for processing and/or analysis. For example, the sensor 134 can detect events/changes around the second housing 112.

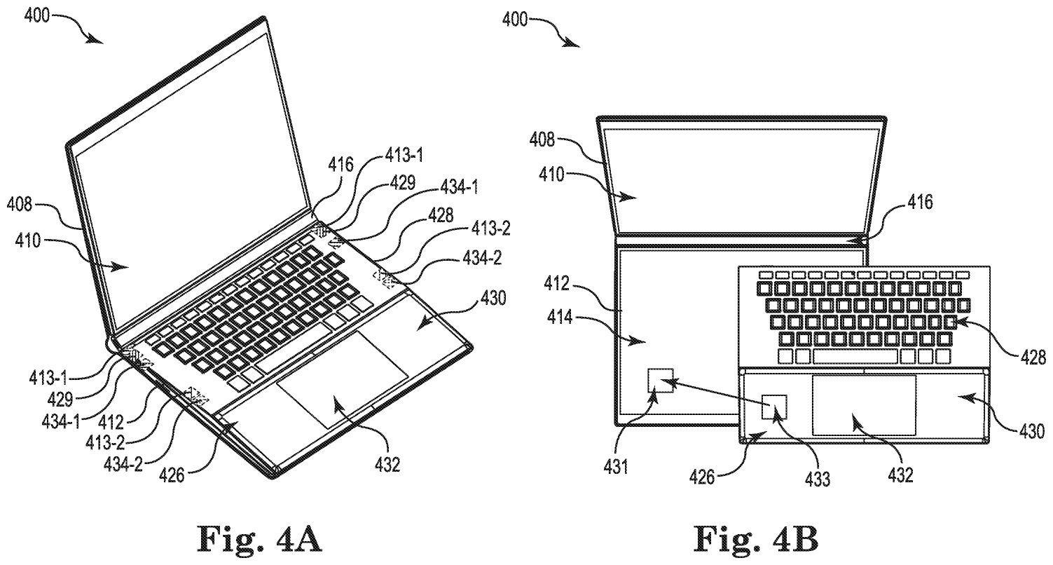

In some examples, the sensor 134 can be a Hall effect sensor. As used herein, the term “Hall effect sensor” refers to a device to measure the magnitude of a magnetic field. Although not illustrated in FIG. 1, the computing device 100 can include a processor, as is further described in connection with FIG. 7. Further, although not illustrated in FIG. 1, in some examples, a keyboard housing can be located on the second housing 112, as is further described in connection with FIGS. 4-6. In response to the Hall effect sensor detecting the keyboard housing is not covering a portion of the second display device 114, the processor can activate the entire display area of the second display device 114. For example, the entire display area of the second display device 114 can be activated such that the entire display area can display text, videos, and/or images. In other words, a user may utilize the computing device 100 when there is no keyboard covering a portion of the second display device 114 by viewing information displayed via the display area of the first display device 110 and/or viewing information displayed via the entire display area of the second display device 114.

When the computing device 100 is in the first open orientation, the computing device 100 is movable to a second open orientation. The first housing 108 and the second housing 112 can be oriented in a folio form factor in the second open orientation, as is further described in connection with FIGS. 7 and 8.

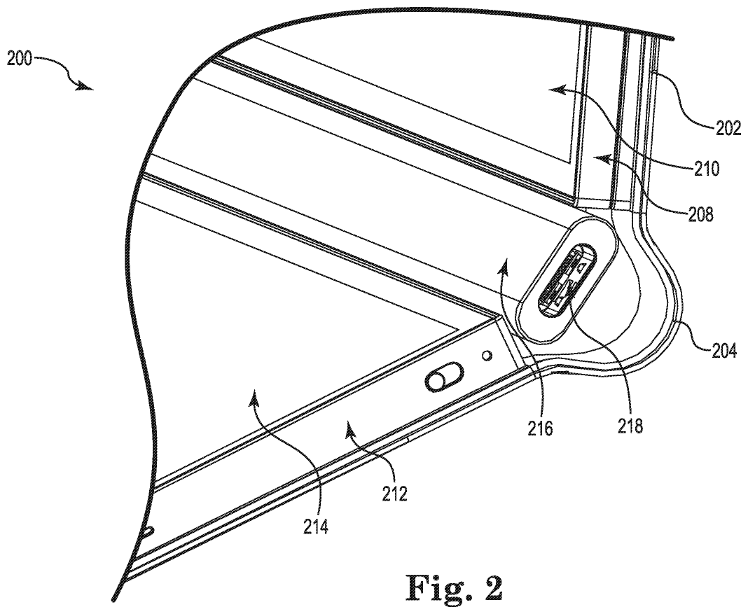

FIG. 2 illustrates a partial perspective view of an example of a computing device 200 with hinge bars having an I/O port 218 consistent with the disclosure. As illustrated in FIG. 2, the computing device 200 can include a cover 202, a first housing 208, a second housing 212, and a hinge bar 216. The cover 202 can include flexible hinge 204. The first housing 208 can include a first display device 210. The second housing 212 can include a second display device 214.

The hinge bar 216 can include an input/output (I/O) port 218 at an end of the hinge bar 216. As used herein, the term I/O port refers to a hardware interface that connects a processor of a computing device to a peripheral device. For example, the I/O port 218 can receive a cable in order to connect a processor of the computing device 200 with a peripheral device.

In some examples, the I/O port 218 can be a universal serial bus (USB) Type-C port. As used herein, the term “USB Type-C” refers to a USB connector system having 24 pins and a rotationally symmetrical connector. The USB Type-C port can be utilized to connect the computing device 200 to a power source in order to charge the computing device 200, connect to a dongle in order to output audio to a 3.5 millimeter (mm) audio jack, allow for connection to an external display device, among other examples.

Although the hinge bar 216 is illustrated in FIG. 2 as including a single USB Type-C I/O port 218, examples of the disclosure are not so limited. For example, the hinge bar 216 can include a second USB Type-C I/O port 218 on an opposite end of the hinge bar 216.

Although not illustrated in FIG. 2, the hinge bar 216 can include an audio output device. As used herein, the term “audio output device” refers to a device capable of converting electrical signals to sound and/or pressure waves. For example, the hinge bar 216 may include an audio output device to output instructions, alerts, voice, multimedia including video and/or music, and/or other types of sounds. For instance, a user may view a video displayed on the first display device 210 and the audio output device can emit music and/or other sounds associated with the video, among other examples. The audio output device can span the length of the hinge bar 216 or be shorter than the length of the hinge bar 216.

FIG. 3 illustrates a partial side view of an example of a computing device 300 with hinge bars in a closed orientation consistent with the disclosure. As illustrated in FIG. 3, the computing device 300 can include a cover 302, a first housing 308, a second housing 312, a hinge bar 316, and a keyboard housing 326. The cover 302 can include flexible hinge 304 and a hinge arm 306. The hinge bar 316 can include an I/O port 318.

As previously described in connection with FIG. 1, the hinge bar 316 can be electrically connected to the first display device included in the first housing 308 and to the second display device included in the second housing 312. As illustrated in FIG. 3, the hinge bar 316 can be electrically connected to the first display device via a first electrical pathway 322. As used herein, the term “electrical pathway” refers to a route which can include a conductive track to carry electric current. For example, the first electrical pathway 322 can allow for electric current to be carried between the first display device included in the first housing 308 and the hinge bar 316.

In some examples, the first electrical pathway 322 can be a flexible printed circuit (FPC). As used herein, the term “FPC” refers to an electronic circuit including an insulating polymer film having conductive circuit traces affixed thereto. The conductive circuit traces of the FPC can carry electric current between the first display device included in the first housing 308 and the hinge bar 316.

The first electrical pathway 322 can be partially located in the cover 302. As indicated by the dashed lines, a portion of the first electrical pathway 322 can be located in the cover 302. The portion of the first electrical pathway 322 located in the cover 302 can allow for electric current to be carried between the first display device included in the first housing 308 and the hinge bar 316 even when the computing device 300 is in the second open orientation, as is further described in connection with FIGS. 7 and 8. The first electrical pathway 322 can extend from the first display device included in the first housing 308 through the cover 302. The other portion of the first electrical pathway 322 not located in the cover 302 can extend from the cover 302 to the hinge bar 316.

The hinge bar 316 can be electrically connected to the second display device via a second electrical pathway 324. For example, the second electrical pathway 324 can allow for electric current to be carried between the second display device included in the second housing 312 and the hinge bar 316.

In some examples, the second electrical pathway 324 can be an FPC. The conductive circuit traces can carry electric current between the second display device included in the second housing 312 and the hinge bar 316. The second electrical pathway 324 can extend from the second display device included in the second housing 312 to the hinge bar 316.

As illustrated in FIG. 3, the computing device 300 is in a closed orientation. As used herein, the term “closed orientation” refers to an orientation in which the first housing 308 and the second housing 312 are oriented in a closed clamshell form factor. For example, the first housing 308 and the second housing 312 can be folded relative to each other such that a surface of the display device included in the first housing 308 and a surface of the display device included in the second housing 312 are substantially proximate to each other. As used herein, the term “substantially” intends that the characteristic does not have to be absolute but is close enough so as to achieve the characteristic. For example, “substantially proximate” is not limited to a particular distance apart. For instance, the surface of the display device included in the first housing 308 and the surface of the display device included in the second housing 312 can be within 0.5 mm, 1 mm, 2 mm, 5 mm, etc. apart from each other.

The closed orientation of the computing device 300 can allow for the computing device 300 to be transported, stored, etc. For instance, the computing device may be powered off, be put into a hibernation state, etc. such that a user may transport the computing device 300 from one location to another, store the computing device 300 for later use, etc.

When the computing device 300 is in the closed orientation, the hinge bar 316 can be nested in the flexible hinge 304. As used herein, the term “nested” refers to one object being at least partially encompassed by another object, the objects being of graduated sizes. For example, the flexible hinge 304 can be slightly larger than the hinge bar 316 such that the flexible hinge 304 partially surrounds the hinge bar 316 when the computing device 300 is in the closed orientation. For instance, as illustrated in FIG. 3, the hinge bar 316 can include an ovular shape and the flexible hinge 304 can include a complimentary ovular shape that can partially encompass the hinge bar 316 such that the ovular shaped hinge bar 316 can be located substantially proximate to the ovular shaped flexible hinge 304 when the computing device 300 is in the closed orientation.

As illustrated in FIG. 3, the computing device 300 can, in some examples, include a keyboard housing 326. The keyboard housing 326 can be positioned between the first housing 308 and the second housing 312 when the computing device 300 is in the closed orientation. In examples in which the keyboard housing 326 is included with the computing device 300, positioning the keyboard housing 326 between the first housing 308 and the second housing 312 can allow for the computing device 300 along with the keyboard housing 326 to be easily and/or conveniently transported, stored, etc. The keyboard housing 326 can include a keyboard, as is further described in connection with FIGS. 4A, 4B, 5, and 6.

FIG. 4A illustrates a perspective view of an example of a computing device 400 with hinge bars in a first open orientation having a keyboard housing 426 including a keyboard 428 consistent with the disclosure. As illustrated in FIG. 4A, the computing device 400 can include a first housing 408, a second housing 412, a hinge bar 416, and a keyboard housing 426. The first housing 408 can include a first display device 410. The keyboard housing 426 can include a keyboard 428 and a palm rest 430.

As illustrated in FIG. 4A, the computing device 400 can be in the first open orientation. For example, the first housing 408 can be oriented at an angle relative to the second housing 412.

The computing device 400 can include a keyboard housing 426. As used herein, the keyboard housing 426 can be an outer shell making up a further different portion of the computing device 400 than the first housing 408 and the second housing 412. The keyboard housing 426 can include other components of the computing device 400, such as a keyboard as is further described herein.

The keyboard housing 426 can include a keyboard 428. As used herein, the term “keyboard” refers to a device utilizing an arrangement of buttons (e.g., keys) to input information into a computing device. A user utilizing the computing device 400 can input information into the computing device 400 via the keyboard 428. For example, a user may be working using the computing device 400 by inputting information into the computing device 400, among other examples.

The keyboard housing 426 can include a palm rest 430. As used herein, the term “palm rest” refers to a device used to support a user's wrists when typing or otherwise utilizing the computing device 400. For example, a user entering information into the computing device 400 utilizing the keyboard 428 may rest their palms on the palm rest 430 in order to be in a comfortable and/or ergonomic position.

The palm rest 430 can include an input device 432. As used herein, the term “input device” refers to a device which sends data to a computing device. In some examples, the input device 432 can be a touchpad. As used herein, the term “touchpad” refers to an input device utilizing a tactile sensor and a specialized surface that can translate the motion and position of a user's finger relative to a position on an operating system of a computing device that is made to output to a display device. For example, a user can utilize the touchpad to move a cursor around a display area of the first display device 410 and/or the second display device. In some examples, the touchpad can include input button(s).

The second housing 412 can be aligned with the keyboard housing 426 at a first position of the keyboard housing 426. As illustrated in FIG. 4A, the keyboard housing 426 can be adjacent to the second housing 412 (e.g., on top of the second housing 412, as oriented in FIG. 4A) at the first position of the keyboard housing 426.

At the first position of the keyboard housing 426, the keyboard housing 426 can cover the second display device included in the second housing 412. For example, the keyboard housing 426 can shield the second display device from view while the keyboard housing 426 is at the first position.

As illustrated in FIG. 4A, the second housing 412 can include magnets 413-1, 413-2. As used herein, the term “magnet” refers to an object that is of a material that produces a magnetic field. Further, the keyboard housing 426 can include magnets 429. The magnets 429 located on the keyboard housing 426 can be magnetically attracted to the magnets 413-1 of the second housing 412, causing the keyboard housing 426 to be magnetically biased to the first position of the keyboard housing 426.

Although not illustrated in FIG. 4A, the computing device 400 can include a processor (e.g., processor 720, as is further described in connection with FIG. 7). The processor can deactivate the entire display area of the second display device in response to determining the keyboard housing 426 is at the first position. For example, the display area of the second display device can be deactivated such that the display area may not be able to display text, videos, and/or images. In other words, a user may utilize the computing device 400 while the keyboard housing 426 is in the first position by inputting information to the computing device 400 via the keyboard 428 and/or viewing information displayed via the display area of the first display device 410. However, no information may be presented to the user for viewing via the display area of the second display device as the second display device is entirely covered by the keyboard housing 426 and the second display area of the second display device is deactivated.

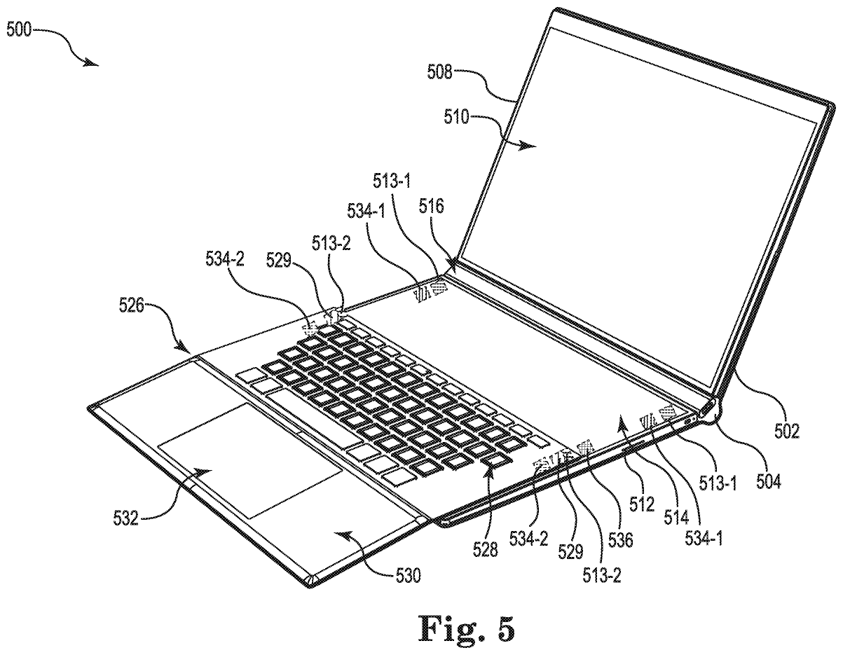

The processor can deactivate the entire display area of the second display device in response to determining the keyboard housing 426 is at the first position. The computing device 400 can include sensors 434-1, 434-2 to determine the position of the keyboard housing 426. The sensors 434-1, 434-2 can be Hall effect sensors. The Hall effect sensors 434-1, 434-2 can transmit an electrical signal to the processor based on a position of the keyboard housing 426. For example, when the keyboard housing 426 is at the first position, the Hall effect sensors 434-1 can sense the presence of a magnetic field (e.g., between the magnets 413-1 of the second housing 412 and the magnets 429 of the keyboard housing 426) and transmit an electrical signal to the processor such that the processor can determine the position of the keyboard housing 426 based on the Hall effect sensors 434-1 located proximate to the magnet 413 of the second housing 412. Different Hall effect sensors (e.g., Hall effect sensors 434-2) can detect different positions of the keyboard housing 426 (e.g., the second position of the keyboard housing 426, as is further described in connection with FIG. 5), allowing the processor to determine the position of the keyboard housing 426 based on the Hall effect sensor that detects a magnetic field and transmits a signal to the processor, as is further described in connection with FIG. 5. Based on the processor determining the keyboard housing 426 is in the first position as a result of the Hall effect sensors 434-1 detecting the magnetic field, the processor can deactivate the entire display area of the second display device.

As illustrated in FIG. 4A, the keyboard housing 426 is in the first position covering the second display device. In an example in which a user may wish to utilize additional display area, the keyboard housing 426 can be moved relative to the second housing 412 to change an amount of alignment with the second housing 412. For example, the keyboard housing 426 can be moved to change an amount of alignment with the second housing 412, which can expose a portion of the display area of the second display device (e.g., as is further described in connection with FIG. 5) or the entire display area of the second display device (e.g., as previously described in connection with FIG. 1).

The keyboard 428 and the input device 432 can be wirelessly connected to the computing device 400. For example, the keyboard 428 can be wirelessly connectable to a processor of the computing device 400. The keyboard 428 can be wirelessly connectable such that a user may utilize the computing device 400 while the keyboard housing 426 is in a detached position (e.g., as illustrated in FIG. 1), in the first position (e.g., as illustrated in FIG. 4A), in a second position (e.g., as illustrated in FIG. 5), and/or in any other position by inputting information to the keyboard 428, and having the information be wirelessly transmitted to the processor of the computing device 400. Information may be input via keystrokes of the keys, via the input device 432, by voice via a microphone of the keyboard 428 (e.g., not illustrated in FIG. 4A), among other input mechanisms.

The keyboard 428 can be wirelessly connected the processor of the computing device 400 via a wireless network relationship. Examples of such a network relationship can include a wireless local area network (WLAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), infrared (IR) communication, Public Switched Telephone Network (PSTN), radio waves, and/or the Internet, among other types of network relationships.

FIG. 4B a top view of an example of a computing device 400 with hinge bars in a first open orientation having a keyboard housing 426 including a keyboard 428 consistent with the disclosure. As illustrated in FIG. 4B, the computing device 400 can include a first housing 408, a second housing 412, a hinge bar 416, and a keyboard housing 426. The first housing 408 can include a first display device 410. The second housing 412 can include a second display device 414. The keyboard housing 426 can include a keyboard 428 and a palm rest 430. The palm rest 430 can include an input device 432.

The second housing 412 can include a transmit device 431 and the keyboard housing 426 can include a receive device 433. As used herein, the term “transmit device” refers to an electronic device that transmits a signal. As used herein, the term “receive device” refers to an electronic device that receives a signal.

As previously described in connection with FIG. 1, the second housing 412 can include components of the computing device 400. Components of the computing device 400 included in the second housing 412 can include electromagnetic shielding in order to isolate electrical devices in the second housing 412. However, the second housing 412 can include a space in the electromagnetic shielding such that the transmit device 431 can wirelessly transmit to the receive device 433 to wirelessly charge a power storage device included in the keyboard housing 426, as is further described herein.

When the computing device 400 is in the first open orientation and the keyboard housing 426 is at the first position (e.g., as illustrated in FIG. 4A), the keyboard 428 can be wirelessly charged at the first position of the keyboard housing 426. For example, when the transmit device 431 is aligned with the receive device 433 when the keyboard housing 426 is at the first position, the computing device 400 can wirelessly charge a power storage device (e.g., not illustrated in FIG. 4B) included in the keyboard housing 426 that powers the keyboard 428 and/or the input device 432.

In some examples, the keyboard 428 can be wirelessly charged if a power storage device of the computing device 400 is above a threshold power amount. For example, a processor (e.g., not illustrated in FIG. 4B) of the computing device 400 can determine a power level of a power storage device of the computing device 400. In response to the power level (e.g., 60%) of the power storage device of the computing device 400 being above a threshold level (e.g., 40%), the computing device 400 can wirelessly charge the keyboard 428. In response to the power level (e.g., 30%) of the power storage device of the computing device 400 being below the threshold level (e.g., 40%), the computing device 400 can prevent wireless charging of the keyboard 428.

FIG. 5 a perspective view of an example of a computing device 500 with hinge bars in a first open orientation having a keyboard housing 526 including a keyboard 528 and a palm rest 530 consistent with the disclosure. As illustrated in FIG. 5, the computing device 500 can include a cover 502, a first housing 508, a second housing 512, a hinge bar 516, and a keyboard housing 526. The cover 502 can include a flexible hinge 504. The first housing 508 can include a first display device 510. The second housing 512 can include a second display device 514. The keyboard housing 526 can include a keyboard 528 and a palm rest 530.

As illustrated in FIG. 5, the computing device 500 can be in the first open orientation. For example, the first housing 508 can be oriented at an angle relative to the second housing 512.

The second housing 512 can include sensor 536. The sensor 536 can detect the orientation of the computing device 500. The sensor 536 can determine whether the computing device 500 is in the first open orientation, a second open orientation, or in a closed orientation. For example, the sensor 536 can determine the computing device 500 is in the first open orientation. In some examples, the sensor 536 can be a light sensor, among other types of sensors.

As previously described in connection with FIG. 4, a user may move the keyboard housing 526 to change an amount of alignment with the second housing 512 such that the keyboard housing 526 is in a second position. Changing the amount of alignment with the second housing 512 can expose a portion of the display area of the second display device 514. That is, the keyboard housing 526 can cover a portion of the second display device 514 at the second position.

As previously described in connection with FIG. 4A, the second housing 512 can include magnets 513-1, 513-2 and the keyboard housing 526 can include magnets 529. The magnets 529 located on the keyboard housing 526 can be magnetically attracted to the magnets 513-2 of the second housing 512, causing the keyboard housing 526 to be magnetically biased to the second position of the keyboard housing 526.

Although not illustrated in FIG. 5, the computing device 500 can include a processor (e.g., processor 720, as is further described in connection with FIG. 7). The processor can activate a portion of the display area of the second display device 514 in response to determining the keyboard housing 526 is at the second position. For example, the portion of the display area of the second display device 514 that is exposed can be activated such that the exposed portion of the display area can display text, videos, and/or images. In other words, a user may utilize the computing device 500 while the keyboard housing 526 is in the second position by inputting information to the computing device 500 via the keyboard 528, viewing information displayed via the display area of the first display device 510, and/or viewing information displayed via the exposed display area of the second display device 514. However, no information may be presented to the user for viewing via the covered display area of the second display device 514 as the covered display area of the second display device 514 is covered by the keyboard housing 526 and the covered display area of the second display device 514 is deactivated (e.g., by the processor).

The processor can activate the exposed display area of the second display device 514 in response to determining the keyboard housing 526 is at the second position. The computing device 500 can include sensors 534-1, 534-2 to determine the position of the keyboard housing 526. The sensors 534-1, 534-2 can be Hall effect sensors. The Hall effect sensors 534-1, 534-2 can transmit an electrical signal to the processor based on a position of the keyboard housing 526. For example, when the keyboard housing 526 is at the second position, the Hall effect sensors 534-2 can sense the presence of a magnetic field (e.g., between the magnets 513-2 of the second housing 512 and the magnets 529 of the keyboard housing 526) and transmit an electrical signal to the processor such that the processor can determine the position of the keyboard housing 526 based on the Hall effect sensors 534-2 located proximate to the magnet 513 of the second housing 512. Based on the processor determining the keyboard housing 526 is in the second position as a result of the Hall effect sensors 534-1 detecting the magnetic field, the processor can activate the exposed area of the second display device 514.

Although the magnets 513-2 are illustrated in FIG. 5 as being at a halfway position in the second housing 512, examples of the disclosure are not so limited. For example, the magnets 513-2 can be in any other location in the second housing 512. Additionally, although there are two sets of magnets 513-1, 513-2 illustrated in FIG. 5 as being included in the second housing 512, examples of the disclosure are not so limited. For example, the second housing 512 can include less than two sets of magnets 513-1, 513-2 or more than two sets of magnets 513-1, 513-2.

Although Hall effect sensors 534 and magnets 513, 529 are described above to determine the position of the keyboard housing 526, examples of the disclosure are not so limited. For example, the computing device 500 can utilize any other type of sensor to determine the position of the keyboard housing 526. Further, although the computing device 500 is described above and illustrated in FIG. 5 as activating half of the display area of the second display device 514, examples of the disclosure are not so limited. For example, the computing device 500 can activate any other amount of the display area based on the position of the keyboard housing 526. In other words, the computing device 500 can activate any exposed portion of the display area of the second display device 514 and deactivate any covered portion of the display area of the second display device 514 based on the location of the keyboard housing 526 relative to the second housing 512 (e.g., based on the amount of alignment of the keyboard housing 526 with the second housing 512).

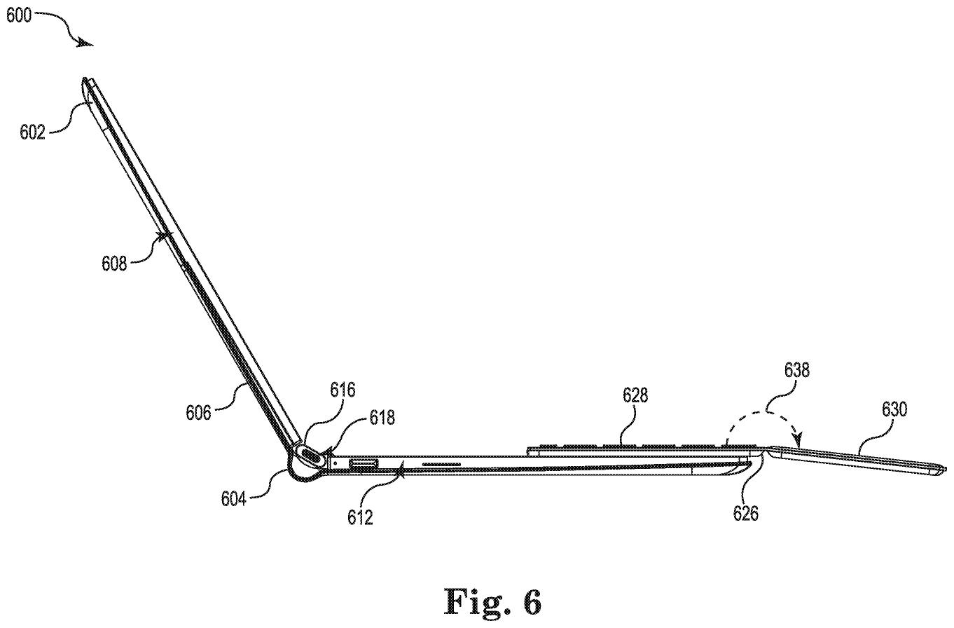

FIG. 6 a side view of an example of a computing device 600 with hinge bars in a first open orientation having a keyboard housing 626 including a keyboard 628 and a palm rest 630 consistent with the disclosure. As illustrated in FIG. 6, the computing device 600 can include a cover 602, first housing 608, a second housing 612, a hinge bar 616, and a keyboard housing 626. The cover 602 can include a flexible hinge 604 and a hinge arm 606. The hinge bar 616 can include an I/O port 618. The keyboard housing 626 can include a keyboard 628 and a palm rest 630.

As illustrated in FIG. 6, the computing device 600 can be in the first open orientation. For example, the first housing 608 can be oriented at an angle relative to the second housing 612.

The keyboard housing 626 can be at the second position. For example, at the second position the keyboard housing 626 can expose a portion of the display area of the second display device included in the second housing 612.

At the second position, the palm rest 630 of the keyboard housing 626 can be oriented at a reflex angle 638 relative to the keyboard 628. As used herein, the term “reflex angle” refers to an angle greater than 180° but less than 360°. For example, the palm rest 630 can rotate 10° to 15° when the keyboard housing 626 is in the second position such that relative to the keyboard 628, the reflex angle 638 can be 190°-195°, although examples of the disclosure are not so limited. For instance, the reflex angle 415 can be less than 195° (but not less than 180°) or greater than 195°.

The palm rest 630 can rotate when the keyboard housing 626 is at the second position to allow for the keyboard housing 626 to be ergonomically oriented for a user. Ergonomically orienting the keyboard housing 626 can allow a user to utilize the keyboard 628 and/or input device 632 of the keyboard housing 626 without discomfort or pain.

FIG. 7 illustrates a perspective view of an example of a computing device 700 with hinge bars in a second open orientation consistent with the disclosure. As illustrated in FIG. 7, the computing device 700 can include a cover 702, a first housing 708, a second housing 712, a hinge bar 716, and a processor 720. The hinge bar 716 an include an I/O port 718. The cover 702 can include a flexible hinge 704 and a hinge arm 706. The first housing 708 can include a first display device 710. The second housing 712 can include a second display device 714.

As previously described in connection with FIG. 3, the hinge bar 716 can be electrically connected to the first display device 710 via the first electrical pathway 722. As illustrated in FIG. 7, the first electrical pathway 722 can be located in the cover 702 and can allow for electric current to be carried between the first display device 710 and the hinge bar 716. Additionally, the hinge bar 716 can be electrically connected to the second display device 714 via a second electrical pathway (e.g., not illustrated in FIG. 7) to allow for electric current to be carried between the second display device 714 and the hinge bar 716.

From the first open orientation (e.g., previously illustrated in FIGS. 1, 4A, 5, and 6), the computing device 700 is movable to a second open orientation. As illustrated in FIG. 7, the computing device 700 can be in the second open orientation. As used herein, the term “second open orientation” refers to an orientation in which the first housing 708 and the second housing 712 are oriented in a folio form factor. For example, from the first open orientation, the first housing 708 can be “pulled forward” by a user and the first housing 708 can rotate away from a portion of the cover 702 about the rotation axis 741. In the second open orientation, the hinge arm 706 can support the first housing 708 as a support stand. The first housing 708 can cover a portion of the second display device 714 in the second open orientation.

As illustrated in FIG. 7, the second housing 712 can include magnets 713. Further, the first housing 708 can include magnets 709. The magnets 709 located in the first housing 708 can be magnetically attracted to the magnets 713 located in the second housing 712, causing the first housing 708 to be magnetically biased to a location on the second housing 712 when the computing device 700 is in the second open orientation.

The second housing 712 can include sensor 736. The sensor 736 can detect the orientation of the computing device 700. The sensor 736 can determine whether the computing device 700 is in the first open orientation, a second open orientation, or in a closed orientation. For example, the sensor 736 can determine the computing device 700 is in the second open orientation. In some examples, the sensor 736 can be a light sensor, among other types of sensors.

The computing device 700 can include a processor 720. The processor 720 can activate a portion of the display area of the second display device 714 in response to determining the computing device 700 is in the second open orientation. For example, in the second open orientation, the first housing 708 can cover a portion of the display area of the second display device 714. The exposed portion of the display area of the second display device 714 can be activated such that the exposed portion of the display area can display text, videos, and/or images. In other words, a user may utilize the computing device 700 while the computing device 700 is in the second open orientation by inputting information to the computing device (e.g., via the touch screen display area of the first display device 710 and/or the activated portion of the second display device 714), viewing information displayed via the display area of the first display device 710, and/or viewing information displayed via the activated portion of the second display device 714.

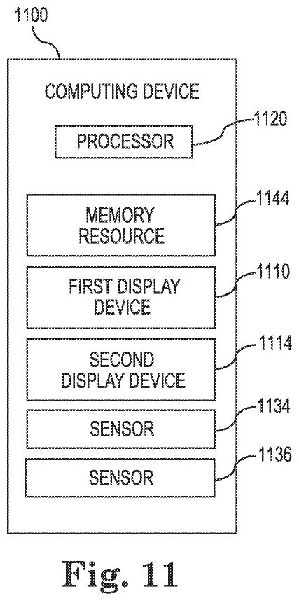

The processor 720 can activate the portion 742 of the display area of the second display device 714 in response to determining the computing device 700 is in the second open orientation. The sensor 736 can determine the orientation of the computing device 700. For example, when the computing device 700 is in the second open orientation, the first housing 708 can be located proximate to the sensor 736. The sensor 736 can, in response, transmit an electrical signal to the processor 720 such that the processor 720 can determine the orientation of the computing device 700 to be in the second open orientation. The processor 720 is further described in connection with FIG. 11.

Although the processor 720 is illustrated in FIG. 7 as being included in the first housing 708, examples of the disclosure are not so limited. For example, the processor 720 can be included in the second housing 712.

As described above, the processor 720 can activate the portion 742 of the display area of the second display device 714. Further, the processor 720 can deactivate the portion 740 of the display area of the second display device 714 that is covered by the first housing 708 in response to the sensor 736 detecting the computing device 700 is in the second open orientation. The portion 742 of the display area of the second display device 714 that is exposed can be activated such that the exposed portion of the display area can display text, videos, and/or images. However, no information may be presented to the user for viewing via the covered and deactivated portion 740 of the display area of the second display device 714. Further, although the computing device 700 is described above and illustrated in FIG. 7 as activating half of the display area of the second display device 714, examples of the disclosure are not so limited. For example, the computing device 700 can activate any other amount of the display area based on the position of the first housing 708. In other words, the computing device 700 can activate any exposed portion of the display area of the second display device 714 and deactivate any covered portion of the display area of the second display device 714 based on the location of the first housing 708 relative to the second housing 712.

Determining the computing device 700 is in the second open orientation can allow the computing device 700 to be in a folio form factor. As used herein, the term “folio form factor” refers to an orientation of a computing device in which one touchscreen display or more than one touchscreen display acts as a main input device , where one of the touch screen displays is supported by a hinge arm. For example, the first display device 710 and/or the second display device 714 can be touch-screen displays that can receive inputs via the display areas of the first display device 710 and/or the second display device 714. The first display device 710 and/or the second display device 714 can receive inputs via a stylus, a human touch input (e.g., a user's finger or fingers), etc., and can allow for gesture input such as pinching/spreading of fingers to zoom, tapping to select, swiping to scroll, among other inputs and associated actions. For instance, a user may view a video displayed on the first display device 710, and control the video utilizing video controls displayed on a touch screen display on the activated portion 742 of the second display device 714. The first display device 710 can be supported by the hinge arm 706.

Although the computing device 700 is described above as receiving inputs via the first display device 710 and/or the second display device 714, examples of the disclosure are not so limited. For example, the computing device 700 can receive inputs via keys of a keyboard and/or an input device of the keyboard included in a keyboard housing (e.g., not illustrated in FIG. 7). The keyboard can be wirelessly connected to the computing device 700 to transmit inputs received via the keyboard and/or the input device to the computing device 700.

Although the sensor 736 is described above as being a light sensor, examples of the disclosure are not so limited. For example, the sensor 736 can be a Hall effect sensor. The Hall effect sensor can detect the magnetic field generated by the magnets 709 and 713. In some examples, the processor 720 can determine the orientation of the computing device 700 based on the detected magnetic field between magnets 709 and 713.

FIG. 8 illustrates a perspective view of an example of a computing device 800 with hinge bars in a second open orientation consistent with the disclosure. As illustrated in FIG. 8, the computing device 800 can include a cover 802, a first housing 808, a second housing 812, and a hinge bar 816. The hinge bar 816 an include an I/O port 818. The cover 802 can include a flexible hinge 804 and a hinge arm 806. The second housing 812 can include a second display device 814.

As previously described in connection with FIG. 7, the computing device 800 can be in a second open orientation. In the second open orientation, the computing device 800 can operate in a tablet mode with the hinge arm 806 supporting the first housing 808. A processor (e.g., not illustrated in FIG. 8) can activate a portion 842 of the display area of the second display device 814 and deactivate a portion 840 of the display area of the second display device 814 based on the determined second open orientation of the computing device 800.

FIG. 9 illustrates a perspective view of an example of a computing device 900 in a plurality of orientations and form factors consistent with the disclosure. As illustrated in FIG. 9, the plurality of orientations and form factors can include a closed orientation 950, a laptop form factor 952, a folio form factor 954, a dual-screen form factor 956, and a tablet form factor 958.

As shown in FIG. 9, the computing device 900 can be in a closed orientation 950. In the closed orientation 950, the computing device 900 can be transported, stored, etc. The cover 902 can protect the computing device 900 from damage.

The computing device 900 can be in the first open orientation and in a laptop form factor 952-1. In the laptop form factor 952-1, the first display device 910 and/or the second display device 914 can receive inputs, display information, etc. The entire second display device 914 can be exposed in the laptop form factor 952-1.

The computing device 900 can be in the second open orientation and in a folio form factor 954-1. In the folio form factor 954-1, the first display device 910 and/or a portion of the second display device 914 can receive inputs, display information, etc. A portion of the second display device 914 can be exposed in the laptop form factor 952-1 and a portion of the second display device 914 can be covered by the first display housing including the first display device 910.

The computing device 900 can be in the second open orientation and in a folio form factor 954-2. In the folio form factor 954-2, the first display device 910 and/or the second display device 914 can receive inputs, display information, etc. The second display device 914 can be facing one direction, while the first display device 910 faces a different direction.

The computing device 900 can be in the first open orientation and in a dual-screen form factor 956-1. In the dual-screen form factor 956-1, the first display device 910 and/or the second display device 914 can receive inputs, display information, etc.

The computing device 900 can be in the first open orientation and in a tablet form factor 958. As used herein, the term “tablet form factor” refers to an orientation of a computing device in which information can be presented on a display. As illustrated in FIG. 9, an angle between the first display device and the second display device 914 can be an angle substantially close to 360°. In the tablet form factor 958, the first display device can be facing away from a user of the computing device 900 and the second display device 914 can receive inputs, display information, etc. Alternatively, although not illustrated in FIG. 9, the second display device 914 can be facing away from a user of the computing device 900 and the first display device can receive inputs, display information, etc.

FIG. 10 illustrates a perspective view of an example of a computing device 1000 in a plurality of orientations and form factors with a keyboard housing consistent with the disclosure. As illustrated in FIG. 10, the plurality of orientations and form factors can include a closed orientation 1050, a laptop form factor 1052, a folio form factor 1054, a dual-screen form factor 1056, and a tablet form factor 1058.

As shown in FIG. 10, the computing device 1000 can be in a closed orientation 1050. In the closed orientation 1050, the computing device 1000 can be transported, stored, etc. The cover 1002 can protect the computing device 1000 from damage.

The computing device 1000 can be in the first open orientation and in a laptop form factor 1052-2 having a keyboard 1028 and palm rest 1030. In the laptop form factor 1052-2, the keyboard 1028 and palm rest 1030 can be resting on the second display device to cover the second display device. The first display device 1010, the keyboard 1028, and/or the palm rest 1030 can receive inputs and the first display device 1010 can display information, etc. The entire second display device can be covered in the laptop form factor 1052-2.

The computing device 1000 can be in the first open orientation and in a laptop form factor 1052-3 having a keyboard 1028 and palm rest 1030. In the laptop form factor 1052-3, the keyboard 1028 can be resting on the second display device 1014 to partially cover the second display device 1014. The palm rest 1030 can be oriented at a reflex angle relative to the keyboard 1028. The first display device 1010, the second display device 1014, the keyboard 1028, and/or the palm rest 1030 can receive inputs and the first display device 1010 and/or the exposed portion of the second display device 1014 can display information. A portion of the second display device 1014 can be covered in the laptop form factor 1052-3.

The computing device 1000 can be in the first open orientation and in a laptop form factor 1052-4 having a keyboard 1028 and palm rest 1030. In the laptop form factor 1052-4, the keyboard 1028 and palm rest 1030 can be resting on a surface proximate to the second display device 1014. The first display device 1010, the second display device 1014, the keyboard 1028, and/or the palm rest 1030 can receive inputs and the first display device 1010 and/or the second display device 1014 can display information. The entire second display device 1014 can be exposed in the laptop form factor 1052-4.

The computing device 1000 can be in the second open orientation and in a folio form factor 1054-3 having a keyboard 1028 and a palm rest 1030. In the folio form factor 1054-3, the keyboard 1028 and the palm rest 1030 can be resting on the second display device and the first display device 1010 can cover the keyboard 1028, where the palm rest 1030 is exposed. The first display device 1010 and/or the palm rest 1030 can receive inputs, and the first display device 1010 can display information, etc. The second display device can be covered by the keyboard 1028 and the palm rest 1030.

The computing device 1000 can be in the second open orientation and in a folio form factor 1054-4 having a keyboard 1028 and a palm rest 1030. In the folio form factor 1054-4, the keyboard 1028 and the palm rest 1030 can be resting on a surface proximate to the second display device 1014 and the first display device 1010 can cover a portion of the second display device 1014, where a different portion of the second display device 1014 is exposed. The first display device 1010, the second display device 1014, the keyboard 1028, and/or the palm rest 1030 can receive inputs, and the first display device 1010 and/or the second display device 1014 can display information.

The computing device 1000 can be in the first open orientation and in a tablet form factor 1058. As illustrated in FIG. 10, an angle between the first display device and the second display device 1014 can be an angle substantially close to 360°. In the tablet form factor 1058, the first display device can be facing away from a user of the computing device 1000 and the second display device 1014 can receive inputs, display information, etc. Alternatively, although not illustrated in FIG. 10, the second display device 1014 can be facing away from a user of the computing device 1000 and the first display device can receive inputs, display information, etc.

The computing device 1000 can be in the first open orientation and in a dual-screen form factor 1056-2 having a keyboard 1028 and a palm rest 1030. In the dual-screen form factor 1056-2, the keyboard 1028 and palm rest 1030 can be resting on a surface proximate to the first display device 1010 and second display device 1014. In the dual-screen form factor 1056-2, the first display device 1010, the second display device 1014, the keyboard 1028, and/or the palm rest 1030 can receive inputs, and the first display device 1010 and/or the second display device 1014 can display information, etc.

The computing device 1000 can be in the second open orientation and in a folio form factor 1054-5 having a keyboard 1028 and a palm rest 1030. In the folio form factor 1054-5, the keyboard 1028 and palm rest 1030 can be resting on the second display device to cover the second display device. The first display device 1010, the keyboard 1028, and/or the palm rest 1030 can receive inputs and the first display device 1010 can display information, etc. The entire second display device can be covered in the folio form factor 1054-5. The second display device can be facing one direction, while the first display device 1010 faces a different direction.

The computing device 1000 can be in the second open orientation and in a folio form factor 1054-6 having a keyboard 1028 and palm rest 1030. In the folio form factor 1054-6, the keyboard 1028 can be resting on the second display device 1014 to partially cover the second display device 1014. The palm rest 1030 can be oriented at a reflex angle relative to the keyboard 1028. The first display device 1010, the second display device 1014, the keyboard 1028, and/or the palm rest 1030 can receive inputs and the first display device 1010 and/or the exposed portion of the second display device 1014 can display information. A portion of the second display device 1014 can be covered in the folio form factor 1054-6. The second display device 1014 can be facing one direction, while the first display device 1010 faces a different direction.

The computing device 1000 can be in the second open orientation and in a folio form factor 1054-7 having a keyboard 1028 and palm rest 1030. In the folio form factor 1054-7, the keyboard 1028 and palm rest 1030 can be resting on a surface proximate to the second display device 1014. The first display device 1010, the second display device 1014, the keyboard 1028, and/or the palm rest 1030 can receive inputs and the first display device 1010 and/or the second display device 1014 can display information. The entire second display device 1014 can be exposed in the folio form factor 1054-7. The second display device 1014 can be facing one direction, while the first display device 1010 faces a different direction.

Computing devices with hinge bars according to the disclosure can utilize a hinge bar electrically connected to a first display device and a second display device that can include a USB Type-C I/O port for connectivity, information transfer, and/or charging of the computing device, among other capabilities. Additionally, a user can utilize the computing device in a first open orientation or a second open orientation, allowing the user to utilize the computing device in a plurality of different form factors. Further, when the computing device is in the second open orientation in a folio form factor, the computing device can present information to a user in two displays, as compared to a single tablet display used in previous approaches. Accordingly, computing devices with hinge bars can provide certain I/O abilities in various form factors while maintaining and/or enhancing portability of the computing device.

FIG. 11 is a diagram of an example computing device 1100 with hinge bars consistent with the disclosure. As described herein, the computing device 1100 may perform functions related to computing devices with hinge bars. Although the following descriptions refer to a single processor and a single memory resource 1144, the descriptions may also apply to a system with multiple processors and multiple memory resources. In such examples, the computing device 1100 may be distributed across multiple memory resources/machine-readable storage mediums and across multiple processors. Put another way, instructions executed by the computing device 1100 may be stored across multiple memory resources/machine-readable storage mediums and executed across multiple processors, such as in a distributed or virtual computing environment.

The processor 1120 may be a central processing unit (CPU), a semiconductor-based microprocessor, and/or other hardware devices suitable for retrieval and execution of non-transitory machine-readable instructions stored in a memory resource 1144. The processor 1120 may fetch, decode, and execute the stored instructions to perform actions related to computing devices with hinge bars. As an alternative or in addition to retrieving and executing the stored instructions, the processor 1120 may include a plurality of electronic circuits that include electronic components for performing the functionality of the stored instructions to perform actions related to computing devices with hinge bars.

The memory resource 1144 may be any electronic, magnetic, optical, or other physical storage device that stores the non-transitory machine-readable executable instructions and/or data. Thus, memory resource 1144 may be, for example, Random Access Memory (RAM), an Electrically-Erasable Programmable Read-Only Memory (EEPROM), a storage drive, an optical disc, and the like. The memory resource 1144 may be disposed within the computing device 1100. Additionally, the memory resource 1144 may be a portable, external or remote storage medium, for example, that causes the computing device 1100 to download the instructions from the portable/external/remote storage medium.

The computing device 1100 can include the first display device 1110 and the second display device 1114. The first display device 1110 and/or the second display device 1114 can present information to a user, such as text, videos, and/or images based on the computing device 1100 being in the first or second open orientation and/or the particular form factor of the computing device 1110 as previously described in connection with FIGS. 1, 4, 5, 7, 9, and 10.

The computing device 1110 can include sensor 1134. The sensor 1134 can be, for example, a sensor to determine a position of a keyboard housing (e.g., not illustrated in FIG. 11), as previously described in connection with FIGS. 1, 4, and 5.

The computing device 1110 can include sensor 1136. The sensor 1136 can be, for example, a sensor to determine whether the computing device 1100 is in the first open orientation, second open orientation, or closed orientation, as previously described in connection with FIGS. 5 and 7.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed:

1. A computing device, comprising:
a cover including a flexible hinge;
a first housing;
a first display device included in the first housing;
a second housing;
a second display device included in the second housing; and
a hinge bar located between the first housing and the second housing, wherein:
the hinge bar includes an input/output (I/O) port at an end of the hinge bar; and
the hinge bar is electrically connected to the first display device via a first electrical pathway located in the cover and to the second display device via a second electrical pathway located between the second display device and the hinge bar.

2. The computing device of claim 1, wherein when the computing device is in a closed orientation a keyboard housing is to be positioned between the first housing and the second housing.

3. The computing device of claim 1, wherein when the computing device is in a first open orientation, the first housing is oriented at an angle relative to the second housing.

4. The computing device of claim 3, wherein when the computing device is in the first open orientation, the second housing is to be aligned with a keyboard housing including a keyboard at a first position of the keyboard housing such that:
the keyboard housing is to cover he second display device at the first position; and
the keyboard is to be wirelessly charged at the first position.

5. The computing device of claim 4, wherein when the computing device is in the first open orientation:
the keyboard housing is movable relative to the second housing to a second position of the keyboard housing to change an amount of alignment with the second housing; and
the keyboard housing is to cover a portion of the second display device at the second position.

6. The computing device of claim 5, wherein:
the keyboard housing includes a palm rest having an input device; and
the palm rest is to be oriented at a flex angle relative to the second housing when the keyboard housing is at the second position.

7. The computing device of claim 1, wherein when the computing device is in a first open orientation, the computing device is movable to a second open orientation.

8. A computing device, comprising:
a cover including a flexible hinge and a hinge arm;
a first housing;
a first display device included in the first housing;
a second housing;
a second display device included in the second housing; and
a hinge bar located between the first housing and the second housing, wherein:
the hinge bar includes an input/output (I/O) port at an end of the hinge bar;
when the computing device is in a closed orientation, the hinge bar is to be nested in the flexible hinge; and
the computing device is rotatable from a first open orientation to a second open orientation such that the hinge arm is to support the first housing and the first housing is to cover a portion of the second display device.

9. The computing device of claim 8, wherein when the computing device is at the second open orientation, the first housing is to be magnetically biased to one of a plurality of locations on the second housing.

10. The computing device of claim 8, wherein when the computing device is at the first open orientation, a keyboard housing is to be magnetically biased to one of a plurality of locations on the second housing.

11. The computing device of claim 8, wherein the hinge bar is electrically connected to the first display device via a first electrical pathway located in the cover of the computing device and to the second display device via a second electrical pathway located between the second display device and the hinge bar.

12. A computing device, comprising:
a cover including a flexible hinge and a hinge arm;
a first housing;
a first display device included in the first housing;
a second housing including a sensor;
a second display device included in the second housing;
a hinge bar located between the first housing and the second housing, wherein:
the hinge bar includes an input/output (I/O) port at an end of the hinge bar;
when the computing device is in a first open orientation, the first housing is to be oriented at an angle relative to the second housing; and
when the computing device is in a second open orientation, the hinge arm is to support the first housing such that the first housing is to cover a portion of the second display device; and
a processor to:
determine an orientation of the computing device via the sensor; and
cause a portion of a display area of the second display device to be activated based on the determined orientation.

13. The computing device of claim 12, wherein the processor is to deactivate, in response to the sensor detecting the computing device is in the first open orientation and a different sensor detecting a keyboard housing is covering a portion of the second display device, the covered amount of the display area of the second display device.

14. The computing device of claim 12, wherein the processor is to activate, in response to the sensor detecting the computing device is in the first open orientation and a different sensor detecting a keyboard housing is not covering a portion of the second display device, an entire display area of the second display device.

15. The computing device of claim 12, wherein the processor is to deactivate, in response to the sensor detecting the computing device is in the second open orientation, the covered portion of the display area of the second display device.
